(19) United States
(12) Patent Application Publication
(10) Pub. No.: US 2012/0280089 A1
(43) Pub. Date: Nov. 8, 2012

(54) Double Slotted Flap for Small Airplane

(76) Inventor: Douglas Otto Keller, West Linn, OR (US)

(21) Appl. No.: 13/461,152

(22) Filed: May 1, 2012

Related U.S. Application Data
(60) Provisional application No. 61/481,345, filed on May 2, 2011.

(51) Int. Cl. B64C 3/50

(52) U.S. Cl. 244/215

(57) ABSTRACT

A short take-off and landing airplane includes double slotted flaps attached to a wing, and a manual control for mechanically deploying the double slotted flaps without hydraulic or electric assistance.

### CROSS REFERENCE TO RELATED APPLICATIONS

This application claims priority to U.S. Provisional Application Ser. No. 61/481,345, filed May 2, 2011 and entitled DOUBLE SLOTTED FLAP FOR SMALL AIRPLANE, the entirety of which is hereby incorporated herein by reference.

### BRIEF DESCRIPTION OF THE DRAWINGS

FIG. 1 shows a modified airplane including a double slotted flap in accordance with an embodiment of the present disclosure.

FIG. 2 shows a rear perspective view of the double slotted flap of FIG. 1.

FIG. 3 shows a front perspective view of the double slotted flap of FIG. 1.

### DETAILED DESCRIPTION OF THE DRAWINGS

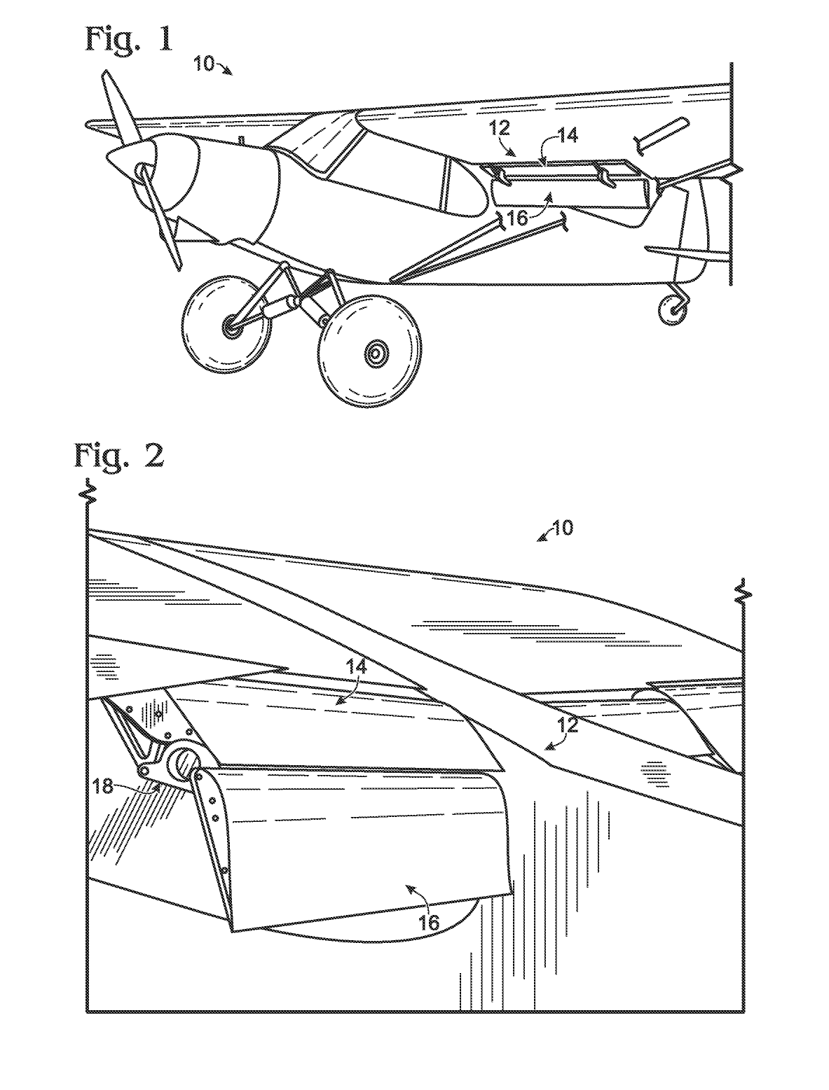

FIG. 1 shows a Piper PA-18 Super Cub airplane 10 modified in accordance with an embodiment of the present disclosure. In particular, airplane 10 includes double slotted flaps 12. Unmodified Piper Super Cub airplanes are light, bush-type aircraft designed to take-off and land in short distances. Such unmodified aircraft include single plain flaps on the wings.

However, the inventor has discovered that the stall speed of such aircraft may be reduced by equipping the small aircraft with double slotted flaps. It is believed that the stall speed may be reduced by at least six miles per hour. The double slotted flaps and resulting reduced stall speed are believed to allow a pilot to take-off and land using smaller unimproved airstrips than previously possible. Furthermore, reduced stall speeds improve safety. By lowering the stall speed, the impact speed and inertia will be drastically reduced in the event of a landing or take-off accident. Furthermore, the double slotted flap allows the pilot to not only fly slower, but to do so at a lower deck angle. The lower deck angle allows for better forward over the nose visibility, which further enhances safety.

While the example aircraft of FIG. 1 is a Piper PA-18 Super Cub, it should be understood that double slotted flaps may be used with virtually any light aircraft in accordance with this disclosure. As nonlimiting examples, double slotted flaps may be used with Cessna 180, Cessna 182, Cessna 185, Cessna 206, Cessna 207, Cessna 208, DeHavilland Beaver, American Champion Scout, Aviat Husky, and Maule Air airplanes, or virtually any other small STOL (short take-off and landing) aircraft originally equipped with single plain or slotted flaps. Furthermore, while the Piper PA-18 Super Cub of FIG. 1 is a modified aircraft on which single plain flaps have been replaced by double slotted flaps, it should be understood that small STOL aircraft may be originally designed and manufactured to include double slotted flaps without departing from the scope of this disclosure.

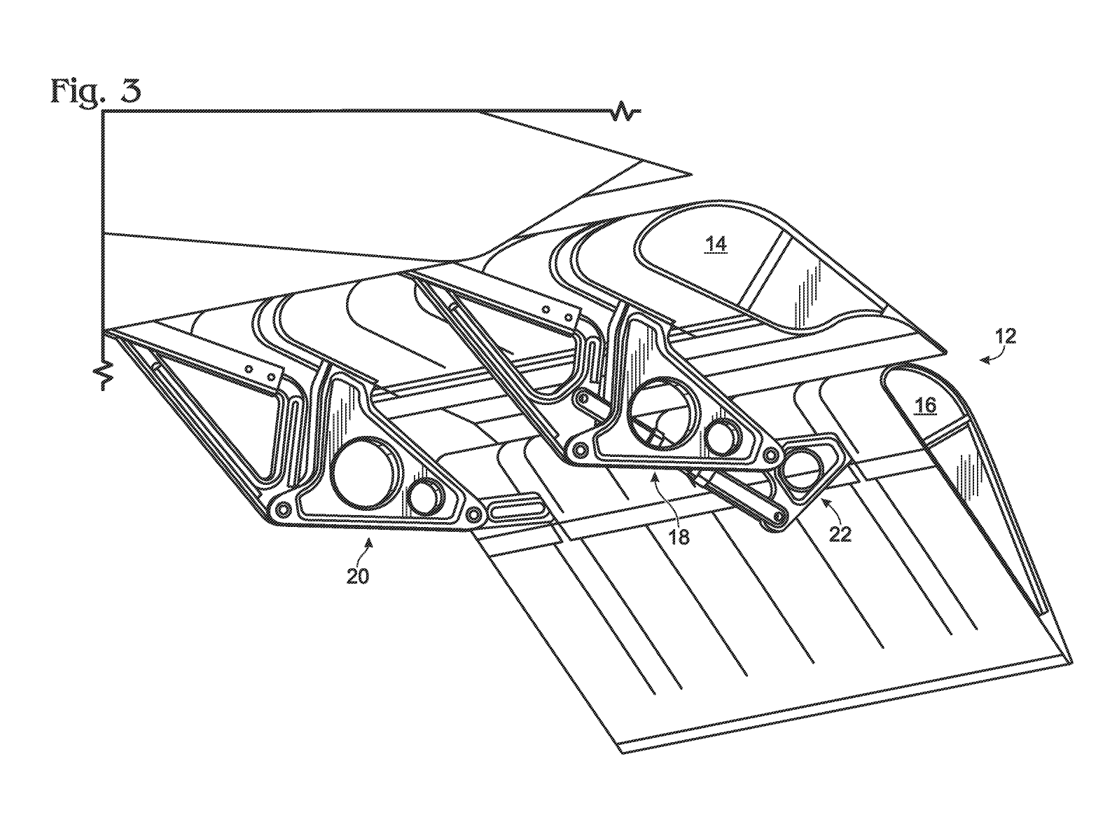

FIGS. 2 and 3 are more detailed views of double slotted flaps 12. The double slotted flaps may be sized and shaped to cooperate with the wing of a small STOL aircraft. In the illustrated embodiment, both the vane 14 and aft flap 16 are 66.5 inches long. The vane 14 is 2¾ inches tall×8½ inches wide. The aft flap 16 is 1½ inches tall×9 inches wide.

The shapes of both the vane 14 and the aft flap 16 are sized appropriately for the PA-18 Super Cub aircraft and allow high energy air to pass through them in a manner that generates high lift and thus a much reduced stall speed.

Double slotted flaps 12 of airplane 10 are operated manually using the original Piper PA-18 flap bell crank in the wing. The pilot operates the unmodified manual flap handle, which deploys the double slotted flaps 12. The vane 14 rotates about the new pivots created by the flap hanger extenders (i.e., inboard flap hanger extender 18 and outboard flap hanger extender 20). The aft flap 16 rotates about a pivot point mounted on the vane. The aft flap is constrained by the link 22 that mounts the aft flap to the inboard flap hanger extender 18. This configuration generates slots between the main wing, vane, and aft flap so that the coefficient of lift is increased, thus lowering the stall speed of the aircraft.

Airplane 10 has been modified to achieve the desired configuration without requiring hydraulics or electric actuators and controls. Furthermore, it is thought that an average skilled mechanic can replace original single slotted flaps with double slotted flaps 12 in 8½ man hours or less. The illustrated modification uses most of the existing wing/flap parts. In particular, the flap bell crank and flap hangers are used. In accordance with the present disclosure, a mechanic removes and replaces the original flap hinge with the new flap hanger extenders (i.e., inboard flap hanger extender 18 and outboard flap hanger extender 20). The mechanic then mounts the new vane 14 and aft flap 16. Some wing fairing rework may be needed in some cases. With this configuration, the original flap bell crank may be used to manually deploy the double slotted flaps 12 without electric or hydraulic actuators, although such actuators may be added.

It is to be understood that the configurations and/or approaches described herein are exemplary in nature, and that these specific embodiments are not to be considered in a limiting sense, because numerous variations are possible. The subject matter of the present disclosure includes all novel and nonobvious combinations and subcombinations of the various features disclosed herein, as well as any and all equivalents thereof.

1. A short take-off and landing airplane, comprising:
a wing;
double slotted flaps attached to the wing; and
a manual control for mechanically deploying the double slotted flaps without hydraulic or electric assistance.

2. A short take-off and landing airplane, comprising:
a wing; and
double slotted flaps attached to the wing, the double slotted flaps being less than six feet long.

3. A modified short take-off and landing airplane, comprising:
a wing;
an original flap hanger configured for a single slotted flap;
a flap hanger extender attached to the original flap hanger; and
double slotted flaps attached to the flap hanger extender.
